(19) United States
(12) Patent Application Publication
(10) Pub. No.: US 2002/0047781 A1
(43) Pub. Date: Apr. 25, 2002

(54) ELECTRONIC LABEL

(76) Inventor: MICHEL FALLAH, CARNOUX (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 09/446,429

(22) PCT Filed: Jun. 15, 1998
(86) PCT No.: PCT/FR98/01245

(30) Foreign Application Priority Data
Jun. 18, 1997 (FR) 9707876

(51) Int. Cl. G08B 13/14

(52) U.S. Cl. 340/572.1; 340/10.1

(57) ABSTRACT

An electronic tag includes an integrated circuit for communicating with an external unit and a detector for detecting at least one physical variable related to the preservation, storage or packaging of a product to which the tag is to be affixed. According to the invention, the detector has an irreversible non-volatile memory for the physical variable or a threshold value thereof. The internal state of the detector being self-modified in the presence of the physical variable or when the physical variable exceeds the threshold value, even in the absence of an electric power source.

### FIELD OF THE INVENTION

The present invention relates to the field of electronic labels or tags, and more particularly, to an electronic label or tag including an integrated circuit.

### BACKGROUND OF THE INVENTION

Recent years have seen the advent on the market of contactless electronic integrated-circuit components that are able to receive and transmit data by electromagnetic induction with the aid of an antenna coil. These integrated circuits have given rise to a new generation of contactless chip cards, and to a new generation of portable electronic articles for non-contact operation known as “electronic tags” or “labels”.

The integrated circuit of an electronic tag includes a memory area, generally an EEPROM memory that can be programmed and erased at will. A variety of data can be recorded, read and replaced in this memory: for example, data identifying the article and information concerning its weight, price, date of manufacture, etc. Electronic tags therefore make it possible to automatically perform various operations such as product identification and tracking, inventory management, production flow monitoring, etc.

In addition to these conventional applications, an electronic tag can be used to detect or monitor a physical variable related to the preservation, storage or packaging of a product to which the tag is to be affixed. For example, the storage and shipping of certain perishable goods must be done in a climate-controlled environment between the time of production and the time of sale. In particular, the storage and shipping of deep-frozen products must take place through a distribution network commonly known as the cold chain. In most industrialized countries, the cold chain is subject to increased monitoring on the part of government agencies responsible for public health.

Also monitored is the irradiation treatment of fresh produce, especially gamma irradiation, which serves to extend the shelf life of vegetables, citrus fruits and other agricultural products. Most legislation therefore makes it mandatory to inform the consumer of the treatments undergone by fresh produce offered for sale. Another example of a physical variable to be monitored is the radioactive radiation that can be emitted by containers used to ship nuclear products. The tools used by the nuclear industry must also be continuously monitored for radioactivity. An electronic tag sensitive to high-energy radiation such as gamma radiation, affixed to a shipping container for radioactive material or to tools of the nuclear industry, can enable such checking to be done automatically. Associated with fresh produce, such a tag can also be used to detect irradiation treatment. A temperature-sensitive electronic tag associated with deep-frozen products can be used to verify the integrity of the cold chain.

Passive-type electronic tags, however, particularly tags powered exclusively by induction, have no independent source of electrical power and are unsuitable for detecting a critical value of a physical variable at an instant when they are not being supplied with electrical power from the external unit.

### SUMMARY OF THE INVENTION

Thus, an object of the present invention is to provide an electronic tag including an integrated circuit for communicating with an external unit and a detector for detecting at least one physical variable related to the preservation, storage or packaging of a product to which the tag is to be affixed. The detector has an irreversible non-volatile memory for the physical variable or for a threshold value thereof. The internal state of the detector is self-modified in the presence of the physical variable or when the physical variable exceeds the threshold value, even in the absence of an electric power supply.

The irreversible memory of the detector can advantageously be replaced in an initial state by the external unit. The irreversible memory of the detector can advantageously be replaced in an initial state with the intervention of a secret code or cryptographic code supplied to the tag by the external unit.

According to an embodiment, the detector includes a material or a substance having electrical or chemical properties that self-modify irreversibly in the presence of the physical variable or when the physical variable exceeds a threshold value. According to an embodiment, the detector includes a semiconductor material. According to an embodiment, the detector includes electrically programmable memory locations. According to an embodiment, the detector includes memory locations possessing different sensitivities to the physical variable.

According to an embodiment, the memory locations erase in response to a form of high-energy radiation. According to an embodiment, the memory locations erase in response to temperature.

According to an embodiment, the detector includes an electric capacitor and a generator of a low current whose intensity is a function of the physical variable to be detected, the current generator being arranged to consume an electrical charge stored in the capacitor. According to an embodiment, the tag can receive a supply voltage for the electronic tag by electromagnetic induction.

In practice, the detector can be disposed in the integrated circuit or can take the form of a separate component disposed in the tag near the integrated circuit and connected therewith. According to an embodiment, the detector is coated with a protective substance.

The present invention also concerns a method for manufacturing an electronic tag according to the invention, wherein the detector is coated with a substance having a conductivity coefficient and a weight selected to impart to the coating substance a thermal inertia selected as a function of the weight of the product to which the tag is to be affixed. According to an embodiment, the detector is coated with a substance having an opacity to radiation selected as a function of a radiation threshold to be detected.

### BRIEF DESCRIPTION OF THE DRAWINGS

These characteristic objects and advantages of the present invention will be described in more detail in the following description of exemplary embodiments of an electronic tag according to the invention, made nonrestrictively with reference to the appended figures, wherein:

FIG. 1 is a electrical block diagram of an electronic tag including a device for detecting a physical variable,

FIG. 2 illustrates a first exemplary embodiment of the detector,

FIG. 3 illustrates a second exemplary embodiment of the detector, and

FIG. 4 illustrates a third exemplary embodiment of the detector.

### DETAILED DESCRIPTION OF THE PREFERRED EMBODIMENTS

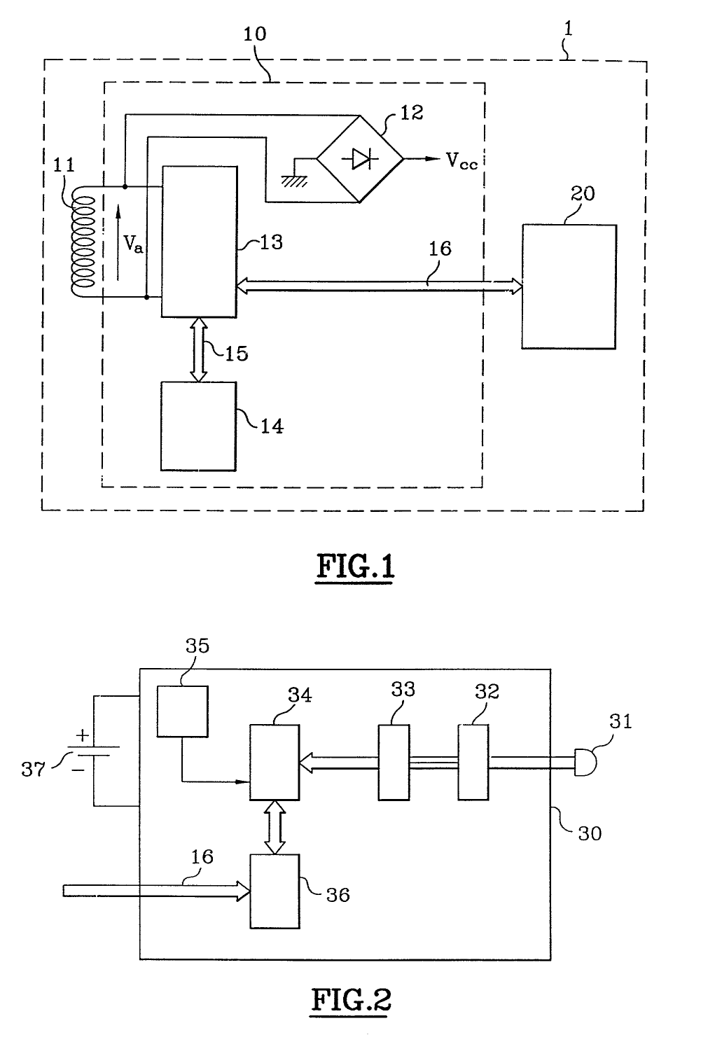

FIG. 1 depicts in block form, the electrical architecture of an electronic tag 1 that can be used in connection with the preservation, storage or packaging of a product. The tag is provided with an integrated circuit 10 that includes, in a conventional manner, an antenna coil 11, a rectifier circuit 12 for supplying a direct-current supply voltage Vcc from an alternating-current voltage Va induced in the coil 11, a central processing unit 13 with hard-wired logic or a microprocessor, and a memory 14, for example an electrically programmable and erasable memory (EEPROM), connected by a bus 15 to the central processing unit 13. Central processing unit 13 performs the conventional operations of demodulating the induced voltage Va for the reception of data from the external unit, modulating the charge of coil 11 for the transmission of data to the external unit, as well as managing the communication protocol with an external unit. “External unit” is intended to mean any electronic device, for example an electronic tag reader, suitable for generating an alternating magnetic field to power the electronic tag, modulating the amplitude of the field in order to transmit data to the tag, and demodulating the amplitude of the field in order to read data transmitted by the tag. Data can thus be read from or written into memory 14 by a central processing unit 13, and the contents of memory 14 can be displayed to a user on a display screen. In addition, the management by central processing unit 13 of the communication protocol with the external unit can include the conventional operations of authentication by cryptographic algorithms. Access to memory 14 can be protected by the presentation to the integrated circuit of a secret code or a password.

Electronic tag 1 also comprises a detector 20 for detecting a physical variable, for example a temperature or radiation, related to a product to which the tag is to be affixed. The detector 20 has a memory so that at a given instant it can deliver at least one datum on a value of the physical variable previously detected. Here, central processing unit 13 is connected to detector 20 via an electrical link 16 comprising one or more wires. Central processing unit 13 thus ensures the reading and the transmission to the external unit of a datum stored by the detector 20 and relating to the detected physical variable.

FIG. 2 depicts an embodiment according to which the detector 20 takes the form of an electronic detector 30 comprising an electrically erasable and programmable memory 36 (EEPROM) to store the values of the physical variable. The detector 30 further comprises a probe 31, a circuit 32 for reading the probe 31, an analog-to-digital converter 33, and a central processing unit 34 associated with a clock 35. Memory 36 is connected by bus 16 to central processing unit 13 of integrated circuit 10.

At regular intervals, for example once every hour, the central processing unit 34 of detector 30 is awakened by clock 35 and activates reading circuit 32 of probe 31. Circuit 32 delivers a measurement of the physical variable to converter 33, which transmits this information in digital form to central processing unit 34. Central processing unit 34 stores the information in memory 36, indicating the date and time of the measurement. Probe 31 is, for example, a temperature probe or a semiconductor-based detector of high-energy radiation.

To avoid saturation of memory 36, the central processing unit 34 may compare the value measured by probe 31 to a set point before proceeding to record it in memory 36. If the measured value is less than the set point, central processing unit 34 does not record the value. For example, in the case of temperature detection, a set point of −10° Celsius can be selected for deep-frozen products, a set point of 5° C. for fresh produce, etc.

In an advantageous manner, memory 36 of the detector 30 is an element of the memory layout of central processing unit 13 of the integrated circuit, “seen” by central processing unit 13 merely as an area of the memory layout defined by a specific address. The contents of memory 36, like those of memory 14, can therefore easily be transmitted to the external unit via coil 11. Clearly, therefore, in this case electrical link 16 can include the wires of the bus 15 connecting the central processing unit to the EPROM memory 14.

In the case of temperature detection, for example, it is therefore possible to check the history of the ambient temperatures withstood by the product to which the tag is attached. An inspection station can perform this operation automatically, and remove questionable products that have been subjected for a predetermined time period or a predetermined number of times to temperatures in excess of a predetermined threshold, all of these criteria being defined according to the product, its weight, etc.

In addition, write access to memory 36 can be blocked in any conventional manner, for example by using a secret code that must be presented to the tag by the external unit, by an authentication code delivered by a cryptographic circuit, etc.

In the embodiment just described, the integrated circuit 10 is a passive circuit, powered by magnetic induction when it is within the transmission range of a tag reading system or an inspection station. At all other times the integrated circuit is deactivated. Under these conditions, a continuous supply of electrical power to detector 30 can be furnished in a simple manner by a small storage battery 37, depicted schematically in FIG. 2, taking the form of a flat pellet containing an electrolyte.

However, a chemical storage battery as a permanent source of electrical energy is susceptible to malfunctions, especially at low temperature, and adds to the cost of the tag. According to a variation, therefore, detector 30 is supplied with power not continuously, but at regular intervals. Detector 30 can have its own power supply system (a coil and a rectifier circuit) or it can be powered by the coil 11 and the rectifier circuit 10 of the integrated circuit 10.

The present invention therefore provides for the following described monitoring procedure. At regular intervals during the storage or shipping of a product to which the electronic tag is affixed (or an assemblage of products arranged in a container), the electronic tag is activated and the date and time of activation are transmitted to it (clock circuit 35 of detector 30 is no longer used). Detector 30 records the ambient temperature in memory 36, and central processing unit 13 appends the date and the time to this information. When the product is presented at an inspection station, all of the data recorded in memory 36 of detector 30 are checked. These recorded data must conform to a set of pre-established product monitoring specifications in terms of temperature and frequency of measurement. If, for example, it is found that a temperature measurement was not performed for several hours, this indicates that the standards for storage of the electronic tag and its activation during storage have not been adhered to, and the product can be considered suspect.

According to another feature of the invention, the above-described disadvantages relating to the electrical power supply of the detection means 20 are eliminated by providing a completely passive electronic tag that requires no continuous source of electrical energy but is still capable of detecting at least one threshold value of the physical variable at any time.

According to the invention, it is proposed that the detector 20 has an irreversible non-volatile memory for storing the physical variable. “Irreversible non-volatile memory” here denotes that the internal electrical or chemical state of the detector 20 self-modifies in the presence of the physical variable. Optionally, it can, however, be provided that the detector can return to its original state after intervention from the external unit. This intervention from the external unit is preferably protected by a secret code, authentication codes obtained by cryptography, etc.

In practice, the detector 20 includes, for example, a material or a constituent having electrical or chemical properties that self-modify irreversibly in the presence of the physical variable or when the physical variable exceeds a threshold value. The constituent can be a chemical compound or a doped semiconductor compound. The internal chemical or electrical state of the constituent is read by central processing unit 13 of integrated circuit 10.

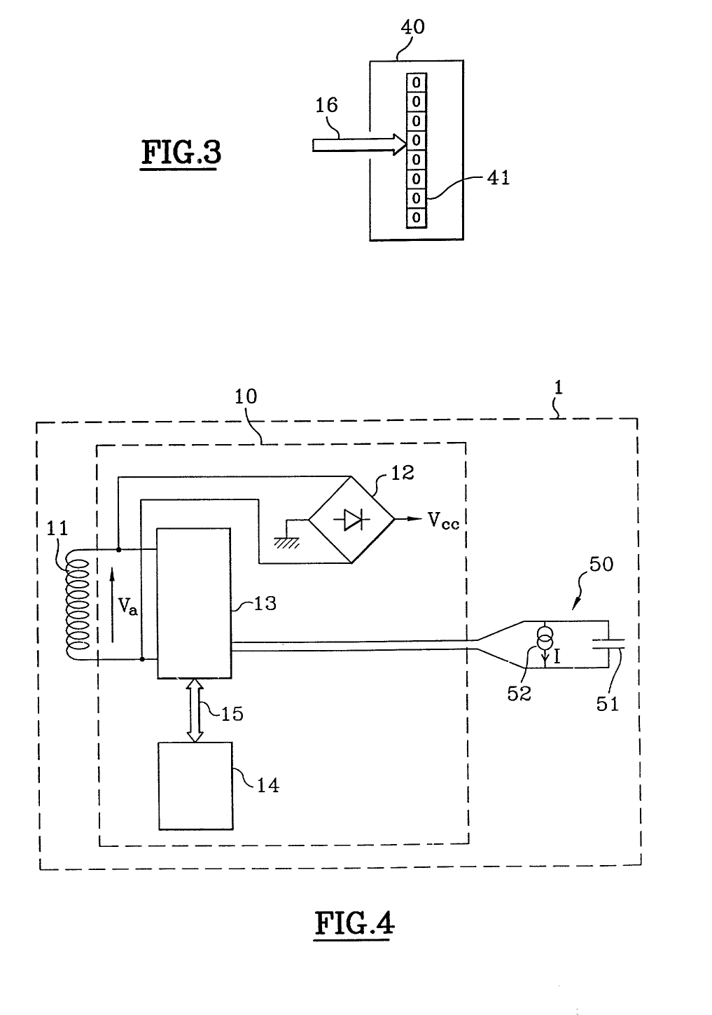

As an example, FIG. 3 is a schematic depiction of an exemplary embodiment in which the detector 20, here a cell 40 detecting high-energy radiation, includes an electrically programmable and ultraviolet-erasable memory 41 (an EPROM memory), for example an 8-bit memory. As before, the memory 41 is read by central processing unit 13 of integrated circuit 10 merely as an area in the memory layout.

All the bits, or memory locations, of memory 41 are electrically programmed to the logical value “0” when the electronic tag is put into service and retain this value indefinitely unless the cell 40 is exposed to high-energy radiation. If the cell is exposed to gamma radiation, for example, these bits are erased and change to the value “1” (the logical value “1” being considered by convention to be the value for erasing bits from an EPROM memory). In this case, therefore, the irreversible non-volatile “memory” effect of cell 40 resides in the fact that the bits of memory 41 are erased when the electronic tag is subjected to a high-energy photon bombardment.

Moreover, and optionally, by adding to memory 41, a filter whose filter coefficient differs according to the memory location concerned, it is possible to give a specific sensitivity to each memory location and thus to create a radiation-sensitivity scale. Under these circumstances, a radiation intensity can be evaluated on the sensitivity scale of the memory locations by determining which bits were erased and which were not.

The passive electronic tag that has just been described lends itself a variety of applications in practice: monitoring or inspection of perishable goods that can be irradiation-treated (the tag can be sealed onto shipping boxes for these goods); detection of any leakage from shipping containers for nuclear materials; monitoring of tools of the nuclear industry for radioactivity, etc. Merely reading the bits in memory 41 via integrated circuit 10 yields pertinent information about the physical variable.

To prevent fraud, the electrical programming to “0” of the bits of memory 41 is preferably protected, for example by a secret code or a cryptographic code that must be presented to the electronic tag and verified by central processing unit 13. In the case of a disposable electronic tag, access to memory 41 can also be definitively barred by the destruction of fuses once the memory has been programmed at the factory.

The electrically programmable memory just described can also be used to detect a temperature threshold by modifying the properties of the doped silicon of which it is composed. In this case, the memory locations of memory 41, for example floating-grid transistors, are made of a semiconductor or a semiconductor junction that releases electrical charges as a function of temperature. For example, the charges that are trapped in the transistor grids when the device is programmed remain trapped below the temperature threshold and the memory locations remain at the logical value “0”. If the temperature threshold is reached, for example a temperature of 0° C., the trapped charges are gradually released and the memory locations are erased. In addition, by imparting a different temperature-sensitivity to each memory location it becomes possible to create a sensitivity scale for the memory, so that a plurality of temperature thresholds can be detected.

FIG. 4 depicts another exemplary embodiment of a completely passive tag in which the detector takes the form of an analog-type cell 50. The cell 50 comprises an electric capacitor 51 disposed in parallel with a current generator 52. When capacitor 51 is charged, current generator 52 delivers a low current I whose intensity is a function of the physical variable. Current generator 52 is sensitive to temperature, for example. Preferably, in this case, current generator 52 does not deliver any current below a threshold temperature. Above the threshold, however, its current output increases as a function of temperature according to a progression selected to be linear, square, exponential, etc., depending on the type of monitoring to be performed. Thus, the charge of capacitor 51 at a given instant depends on the temperatures above the threshold to which it has been exposed and the time of exposure to the temperatures.

Current generator 52 can also be sensitive to radiation, and can, for example, include photosensitive cells that determine the current output. In practice, the terminals of capacitor 51 are connected to central processing unit 13. When the electronic tag goes into service, capacitor 51 is precharged to a voltage Vch by central processing unit 13, preferably in a protected manner, for example with the intervention of a secret code supplied to central processing unit 13 by the external unit and/or the presentation of an authentication code obtained by cryptography.

During a monitoring procedure, central processing unit 13 is activated by induction and takes a reading or a measurement of the charge of capacitor 51, or of its leakage current I in current generator 52, or alternatively of any parameter representative of irreversible changes in the electrical state of capacitor 51. Central processing unit 13 stores the representative parameter in digital form in memory 14 or transmits it directly to the inspection station. If the representative parameter is outside a range of authorized values, the product is considered to be suspect.

The present invention is, of course, susceptible to many other variations and embodiments. For instance, although detector 20 and integrated circuit 10 have been described as separate components, it is readily apparent that the detector can be incorporated into the integrated circuit. Conversely, the detector 20 can take the form of a silicon microchip separate from the integrated circuit and can possess a certain “intelligence” that enables the detector, for example, to interact with the integrated circuit via a serial or parallel link.

In practice, the electronic tag according to the invention is realized according to the rules of the art. For example, integrated circuit 10 and detector 20 (if separate from the integrated circuit) are mounted on a common substrate and are protected by a drop of a protective substance, for example an epoxy resin. The electrical connection of the integrated circuit to the detector can be effected by hard-wiring with ultrasonically welded wires.

According to another, optional feature of the invention, the protective substance used to coat the detector 20 is selected to possess specific characteristics related to the physical variable to be detected. In the case of temperature detection, one would, for example, choose the thermal conductivity coefficient and the weight of the coating substance.

Selecting the thermal properties of the coating substance in this way and calibrating its weight (it can also be calibrated by volume) makes it possible to control the thermal capacity of the substance and the thermal inertia of the detector. The advantage is that the electronic tag is given a thermal inertia that is a function of the product to which it is affixed, so that the information delivered by the tag is adapted to the product. For example, a deep-frozen product with a weight of 10 kg requires a much longer thawing time than a deep-frozen product of a hundred or so grams. More than one calibration of the coating substance can therefore be provided, so that a tag stores a critical temperature, for example 0° C. for deep-frozen products, only if it has been exposed to that temperature for a period of time appropriate to the weight of the product, for example 15 minutes for heavy goods, 10 minutes for lighter goods, etc.

For the detection of hard radiation, the specific characteristics of the coating substance can include a filtering effect selected as a function of a radiation threshold that one wishes to detect. These characteristics of the coating substance can replace or, on the contrary, be combined with the characteristic described hereinabove including imparting a sensitivity scale to the detector.

In addition, it is readily apparent that an electronic tag according to the invention can possess more than one detector 20 at a time. In particular, the various detectors described hereinabove can be combined in a single tag. Furthermore, although an electronic tag comprising an integrated circuit powered by electromagnetic induction has been described hereinabove, it is readily apparent that the present invention can apply to an electronic tag powered by contacts and communicating in this manner with the external unit.

Finally, although the primary concern in the foregoing has been to describe the characteristics of the detector, it should be noted that an electronic tag according to the invention is not a mere integrated detector, but can also possess the distinctive characteristics of an electronic tag, i.e., the fact of being able to store data relating to the product to which it is affixed, the data permitting the identification of the product, its management, etc., and the fact of being able to communicate with the outside world in a protected manner, for example with the intervention of a secret code, a cryptographic algorithm, etc.. All of these properties give the tag according to the invention a very broad range of potential industrial and commercial applications.

That which is claimed is:

1. An electronic tag (1) comprising an integrated circuit (10) including means of communication (11, 13) with an external unit and means (20, 40, 50) for detecting at least one physical var
the tag is to be affixed, characterized in that the detection means (20, 40, 50) has an irreversible non-volatile memory (41, 51) for storing the physical variable or a threshold value thereof, the internal state of the det
the physical variable or when the physical variable exceeds said threshold value, even in the absence of an electric power supply.

2. A tag according to claim 1, wherein the irreversible memory (41, 51) of the detection means (40, 50) can be replaced in an initial state by the external unit.

3. A tag according to claim 2, wherein the irreversible memory (41, 51) of the detection means (40, 50) can be replaced in an initial state with the intervention of a secret code or a cryptographic code supplied to the tag by the external unit.

4. A tag according to any of claims 1 to 3, wherein the detection means (40) includes a material or a substance having electrical or chemical properties that self-modify irreversibly in the presence of the physical variable or when the physical variable exceeds a threshold value.

5. A tag according to claim 4, wherein the detection means (40) includes a semiconductor material.

6. A tag according to either of claims 4 and 5, wherein the detection means (40) includes electrically programmable memory locations (41).

7. A tag according to claim 6, wherein the detection means (40) includes memory locations (41) having different sensitivities to the physical variable.

8. A tag according to either of claims 6 and 7, wherein the memory locations erase in response to a form of high-energy radiation.

9. A tag according either of claims 6 and 7, wherein the memory locations erase in response to temperature.

10. A tag according to any of the preceding claims, wherein the detection means (50) includes an electrical capacitor (51) and a generator (52) of a low current (I) whose intensity is a function of the physical variable to be detected, said current generator (52) being arranged to consume an electrical charge stored in the capacitor (51).

11. A tag according to any of the preceding claims, comprising means (11, 12) for receiving a supply voltage for the electronic tag by electromagnetic induction.

12. A tag according to any of the preceding claims, wherein the detection means (40, 50) is disposed in the integrated circuit (10).

13. A tag according to any of claims 1 to 11, wherein the detection means (40, 50) takes the form a separate component disposed in the tag near the integrated circuit, said integrated circuit including means for connection (16) to the detection means.

14. A tag according to any of the preceding claims, wherein the detection means (40, 50) is coated with a protective substance.

15. A method for manufacturing an electronic tag according to claim 14, wherein the detection means (40, 50) is coated with a substance having a conductivity coefficient and a weight selected to impart to the coating substance a thermal inertia selected as a function of the weight of the product to which the tag is to be affixed.

16. A method for manufacturing an electronic tag according to claim 14, wherein the detection means (40, 50) is coated with a material having an opacity to radiation selected as a function of a radiation threshold to be detected.
